(19) United States
(12) Patent Application Publication
(10) Pub. No.: US 2026/0298185 A1
(43) Pub. Date: Oct. 1, 2026

(54) FUEL SUPPLY DEVICE

(71) Applicant: Nikki Co., Ltd., Kanagawa-ken (JP)

(72) Inventors: Masanori Yasaki, Kanagawa-ken (JP); Tsutomu Murakami, Kanagawa-ken (JP)

(21) Appl. No.: 19/635,242

(22) Filed: Mar. 31, 2026

(30) Foreign Application Priority Data
Mar. 31, 2025 (JP) 2025-058898

(51) Int. Cl. F02M 37/04; B63H 21/38; F02M 37/00

(52) U.S. Cl. CPC F02M 37/04; B63H 21/38; F02M 37/007

(57) ABSTRACT

A fuel supply device configured to be disposed midway along a fuel supply path between a main fuel tank and an engine may include a fuel storage tank also functioning as a reservoir tank, a housing in which the fuel storage tank is disposed, a fuel pump, a vapor discharge portion, a plurality of harnesses, and at least one harness binding member. The harnesses may extend from the fuel pump and may be connected to an external connection terminal, which may be installed on an inner surface side of the housing. The harness binding member may be attached to at least some of the harnesses from an outer side and may be configured to bind at least some of the harnesses in the housing.

### CROSS-REFERENCE TO RELATED APPLICATION

This application claims priority to Japanese Patent Application No. JP2025-058898, filed on March 31, 2025, the content of which is hereby incorporated by reference in its entirety.

### TECHNICAL FIELD

The present invention relates to a fuel supply device disposed midway along a fuel supply path formed between a main fuel tank and an engine and including a fuel storage tank that also functions as a reservoir tank, and particularly relates to a fuel supply device for an outboard motor.

### BACKGROUND

In the related art, as a fuel supply device (vapor separator tank (VST)) that is disposed midway along a fuel supply path formed between a main fuel tank and an engine and includes a fuel storage tank that also functions as a reservoir tank, there is known a fuel supply device including: a housing having a fuel storage tank therein; a fuel pump disposed in the housing and configured to pressure-feed fuel in the fuel storage tank; and a vapor discharge portion configured to discharge vapor in the fuel storage tank to outside of the housing (see, for example, JP 2022-18488 A).

### SUMMARY

In such a fuel supply device described in JP 2022-018488 A, a plurality of harnesses extending from the fuel pump and connected to an external connection terminal installed on an inner surface side of the housing are provided for power supply and signal communication, but it has been found that there is room for improvement regarding damage to these harnesses.

Accordingly, the present invention solves these problems, and an object of the present invention is to provide a fuel supply device that inhibits damage to harnesses in a housing with a simple configuration.

To solve the above problem, the present invention provides a fuel supply device that is disposed midway along a fuel supply path formed between a main fuel tank and an engine and includes a fuel storage tank that also functions as a reservoir tank. The fuel supply device includes: a housing having the fuel storage tank therein; a fuel pump disposed in the housing and configured to pressure-feed fuel in the fuel storage tank; a vapor discharge portion configured to discharge vapor inside the fuel storage tank to outside of the housing; and a plurality of harnesses extending from the fuel pump and connected to an external connection terminal installed on an inner surface side of the housing. The fuel supply device further includes a harness binding member attached to at least some of the plurality of harnesses from an outer side and configured to bind the at least some harnesses in the housing.

According to the present invention, it is possible to inhibit damage to harnesses in the housing with a simple configuration.

### BRIEF DESCRIPTION OF DRAWINGS

FIG. 1 is a perspective view illustrating a fuel supply device according to an embodiment of the present invention;

FIG. 2 is an explanatory view illustrating a configuration in a housing;

FIG. 3 is an explanatory view illustrating the vicinity of harnesses in a state where a harness binding member is not attached;

FIG. 4 is an explanatory view illustrating the vicinity of the harnesses in a state where a fuel pump is removed and the harness binding member is not attached;

FIG. 5 is an explanatory view illustrating the harnesses in a state where the harness binding member is attached; and

FIG. 6 is an explanatory view illustrating the harnesses in a state where the harness binding member is attached.

### DETAILED DESCRIPTION

Hereinafter, a fuel supply device 10 according to an embodiment of the present invention will be described with reference to the drawings.

First, in the present embodiment, the fuel supply device 10 is configured as a fuel supply device (vapor separator tank (VST)) for an outboard motor. The fuel supply device 10 is disposed midway along a fuel supply path formed between a main fuel tank (not illustrated) installed on a hull of a ship such as a motor boat and an engine (not illustrated) of the outboard motor, and includes a fuel storage tank 20a that also functions as a reservoir tank for storing fuel from the main fuel tank and supplying the fuel to the engine.

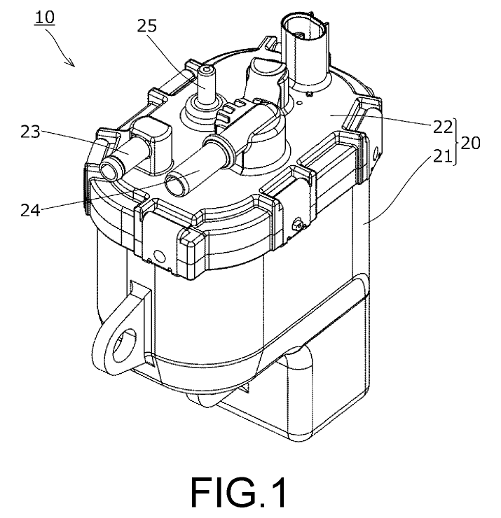

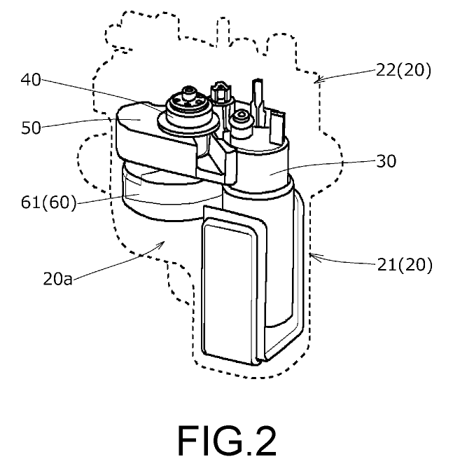

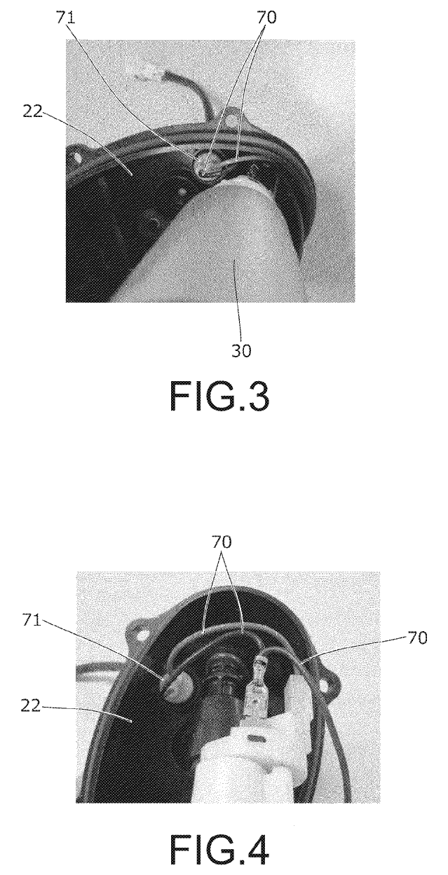

As illustrated in FIGS. 1 and 2, the fuel supply device 10 includes: a housing 20 having the fuel storage tank 20a therein; an electric fuel pump 30 disposed in the housing 20 and configured to pressure-feed the fuel in the fuel storage tank 20a; a vapor discharge portion 25 configured to discharge vapor in the fuel storage tank 20a to outside of the housing 20; a regulator 40 configured to return surplus fuel to the fuel storage tank 20a while adjusting the fuel pressure-fed by the fuel pump 30 to a predetermined pressure; a regulator holding member 50 configured to support the regulator 40 at an upper side of the fuel storage tank 20a; a fuel storage amount adjustment unit 60 configured to maintain a liquid level of the fuel stored in the fuel storage tank 20a at a constant level; a plurality of harnesses 70 extending from the fuel pump 30 and connected to an external connection terminal (not illustrated) installed on an inner surface side of the housing 20; and a harness binding member 80 configured to bind the harnesses 70.

Hereinafter, a specific configuration of each component of the fuel supply device 10 will be described with reference to the drawings.

First, the housing 20 is formed of synthetic resin or the like and includes a housing body 21 and a lid body 22 attached to the housing body 21 to airtightly close an opening of the housing body 21 as illustrated in FIG. 1.

As illustrated in FIG. 1, a fuel introduction pipe 23 introducing fuel into the fuel storage tank 20a, a fuel discharge pipe 24 discharging the fuel from the fuel storage tank 20a, and an atmosphere communication pipe 25 communicating between inside and outside of the housing 20 are provided on an upper surface of the lid body 22.

The atmosphere communication pipe 25 functions as a vapor discharge portion 25 discharging vapor (evaporated fuel) and air generated in the fuel storage tank 20a to the outside of the housing 20.

The fuel storage amount adjustment unit 60 is configured to maintain a liquid level of the fuel stored in the fuel storage tank 20a at a constant level while opening and closing a valve at a proximal end side of a valve lever (not illustrated) having a float 61 on a distal end side in a cantilever manner.

Each harness 70 is used to connect the fuel pump 30 to a connection target (specifically, an electronic apparatus such as a battery) outside of the housing 20 for power supply and signal communication. In the present embodiment, one end of each harness 70 is connected to the fuel pump 30, and the other end of each harness 70 has a harness terminal 71 connected to an external connection terminal (not illustrated) provided on the inner surface side of the housing 20 (lid body 22).

The harness 70 is connected to the connection target outside of the housing 20 by being connected to the external connection terminal.

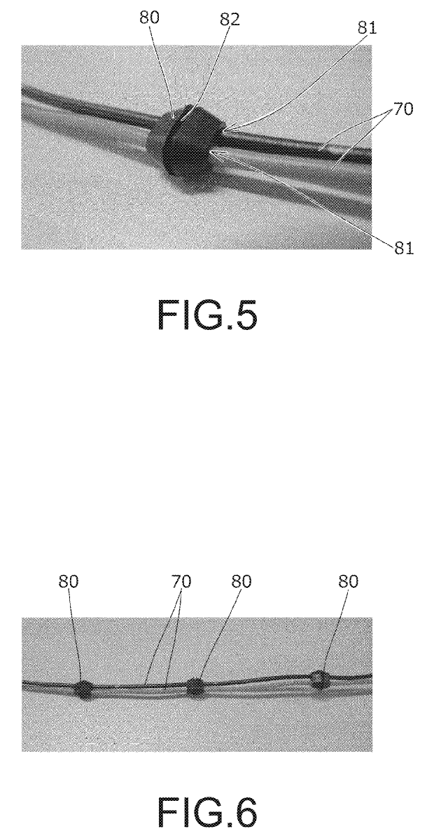

The harness binding member 80 is formed of an elastic material such as synthetic rubber, and as illustrated in FIGS. 5 and 6, is attached to at least some (two in the present embodiment) of the plurality of harnesses 70 in the housing 20 from the outer side of the harnesses 70 to bind these harnesses 70.

As illustrated in FIG. 5, the harness binding member 80 has a plurality of harness insertion holes 81 through which the harnesses 70 are independently inserted.

In the present embodiment, as illustrated in FIG. 6, the harness binding member 80 is attached to the harnesses 70 at a plurality of locations separated from each other in a longitudinal direction of the harnesses 70.

As illustrated in FIG. 5, each harness binding member 80 has a groove 82 recessed in an outer surface thereof.

The groove 82 is fitted to a part of the housing 20 (in the present embodiment, the lid body 22) in a state where the harnesses 70 are disposed in the housing 20, so that movement of the harnesses 70 is restricted.

In the fuel supply device 10 according to the present embodiment configured as described above, the harness binding member 80 is provided, which is attached from the outer side to at least some of the plurality of harnesses 70 in the housing 20 to bind the at least some harnesses 70. Therefore, even when the fuel supply device 10 is installed in an environment where the fuel supply device 10 shakes, when the harnesses 70 swing, it is possible to cause the harness binding member 80 to collide with a peripheral portion such as an inner wall of the housing 20 before the harnesses 70, and collision between the harnesses 70 can be inhibited. Thus, damage to the harnesses 70 can be inhibited.

Since the harness binding member 80 has the plurality of harness insertion holes 81 through which the harnesses 70 are independently inserted, it is possible to prevent the harnesses 70 from rubbing against each other at a bound portion. Therefore, it is possible to further inhibit the damage to the harnesses 70.

Since the harness binding member 80 is disposed in a state where the groove 82 recessed in the outer surface thereof is fitted to a part of the housing 20, movement of the harnesses 70 in the housing 20 can be restricted to inhibit damage to the harnesses 70, and a connection state of the harnesses 70 to the external connection terminal provided on the inner surface side of the lid body 22 can be favorably maintained. When the fuel supply device 10 is assembled, the harness binding member 80 attached to the harnesses 70 is attached to the housing 20 (in the present embodiment, the lid body 22), and thus it is easy to handle the housing 20 (in the present embodiment, the lid body 22) and the harnesses 70.

Further, since the harness binding members 80 are attached to the harnesses 70 at a plurality of locations separated from each other in the longitudinal direction of the harnesses 70, it is possible to inhibit damage to the harnesses 70 along the longitudinal direction of the harnesses 70.

Since the harness binding member 80 is formed of an elastic material, it is possible to inhibit damage to the harness binding member 80 itself, the harnesses 70, and the peripheral portion around the harnesses 70. Further, it is possible to stabilize the attachment state of the harness binding member 80 to the housing 20 (in the present embodiment, the lid body 22).

When the fuel supply device 10 is configured as a fuel supply device for an outboard motor, the fuel supply device 10 is installed in an environment where the fuel supply device 10 is greatly shaken during operation of a ship. Therefore, the effect of inhibiting damage to the harnesses 70 by the above-described harness binding member 80 becomes more pronounced.

Although the embodiment of the present invention has been described in detail above, the present invention is not limited to the above embodiment, and various design changes can be made without departing from the scope of the present invention defined in the claims. For example, the fuel supply device 10 may be configured by selectively combining the configurations of the embodiments and the modifications described above and below.

For example, in the above-described embodiment, it has been described that the plurality of harness insertion holes 81 are formed so that the harnesses 70 are independently inserted. However, the harness insertion hole 81 may be formed so that a plurality of harnesses 70 are collectively inserted, instead of receiving only a single harness 70.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader’s understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase “at least one of” followed by successive elements separate by the word “and” (e.g., “at least one of A and B”) is to be interpreted the same as “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

1. A fuel supply device configured to be disposed midway along a fuel supply path formed between a main fuel tank and an engine and including a fuel storage tank also functioning as a reservoir tank, the fuel supply device comprising:
a housing including the fuel storage tank therein;
a fuel pump disposed in the housing and configured to pressure-feed fuel in the fuel storage tank;
a vapor discharge portion configured to discharge vapor inside the fuel storage tank to outside of the housing;
a plurality of harnesses extending from the fuel pump and connected to an external connection terminal installed on an inner surface side of the housing; and
a harness binding member attached to at least some of the plurality of harnesses from an outer side and configured to bind the at least some of the plurality of harnesses in the housing.

2. The fuel supply device according to claim 1, wherein the harness binding member has a plurality of harness insertion holes through which the at least some of the plurality of harnesses are independently inserted.

3. The fuel supply device according to claim 1, wherein the harness binding member is disposed in a state where a groove recessed in an outer surface of the harness binding member is fitted to a part of the housing.

4. The fuel supply device according to claim 1, further comprising a plurality of harness binding members including the harness binding member, wherein the plurality of harness binding members are attached to the at least some of the plurality of harnesses at a plurality of locations separated from each other in a longitudinal direction of the plurality of harnesses.

5. The fuel supply device according to claim 1, wherein the harness binding member is formed of an elastic material.

6. The fuel supply device according to claim 1, wherein the fuel supply device is configured as a fuel supply device for an outboard motor.

7. A fuel supply device configured to be disposed midway along a fuel supply path between a main fuel tank and an engine, the fuel supply device comprising:
a housing;
a fuel storage tank configured to function as a reservoir tank, the fuel storage tank disposed in the housing;
a fuel pump disposed in the housing and configured to pressure-feed fuel in the fuel storage tank;
a vapor discharge portion configured to discharge vapor inside the fuel storage tank to outside of the housing;
an external connection terminal arranged on an inner surface side of the housing;
a plurality of harnesses connected to the fuel pump at a first end and connected to the external connection terminal at a second end; and
at least one harness binding member attached to at least some of the plurality of harnesses from an outer side and binding the at least some of the plurality of harnesses to one another in the housing.
